(19) United States
(12) Patent Application Publication
(10) Pub. No.: US 2026/0217576 A1
(43) Pub. Date: Jul. 30, 2026

(54) AMMONIA SLIP MITIGATION SYSTEMS AND METHODS

(71) Applicant: CPV Power Holdings, LP, Silver Spring, MD (US)

(72) Inventors: Dipankar Sahoo, Vienna, VA (US); Jeff Berdell Ahrens, Beverly, MA (US); Jon Peter Donovan, Norton, MA (US)

(73) Assignee: CPV Power Holdings, LP, Silver Spring, MD (US)

(21) Appl. No.: 19/555,584

(22) Filed: Mar. 3, 2026

Related U.S. Application Data
(63) Continuation of application No. 19/293,695, filed on Aug. 7, 2025, now abandoned.
(60) Provisional application No. 63/750,620, filed on Jan. 28, 2025.

(51) Int. Cl. C02F 1/66; B01D 53/34; B01D 53/58; B01D 53/94; C02F 101/16; F01K 23/10; F01N 3/20

(52) U.S. Cl. CPC C02F 1/66; B01D 53/343; B01D 53/58; B01D 53/9418; F01K 23/10; F01N 3/2073; B01D 2257/406; B01D 2258/0283; C02F 2101/16; C02F 2209/06; C02F 2209/14; F05D 2220/72; F05D 2220/74; F05D 2270/0831

(57) ABSTRACT

A method for removing ammonia from a condensate, the method comprising the steps of introducing a flue gas to a direct contact cooler, the flue gas comprising a gas selected from the group consisting of carbon dioxide, nitrogen, oxygen, water vapor, ammonia, and combinations of the same; contacting the flue gas with a water feed in the direct contact cooler to produce a cooled flue gas and the condensate; introducing the condensate to an ammonia stripper; contacting the condensate with an air feed to produce an air product and a wastewater; introducing a carbonic acid feed to the treatment unit, the treatment unit configured to modify the pH of the wastewater; and mixing the wastewater with the carbonic acid feed in the treatment unit to produce a treated water.

### CROSS-REFERENCE TO RELATED APPLICATIONS

This patent application is a continuation of U.S. Non-Provisional patent application Ser. No. 19/293,695, filed on Aug. 7, 2025, which claims priority from U.S. Provisional Application Ser. No. 63/750,620 filed on Jan. 28, 2025. For purposes of United States patent practice, each application is incorporated by reference in its entirety.

### TECHNICAL FIELD

Disclosed are methods and systems for treating a flue gas stream. Specifically, disclosed are systems and methods for capturing ammonia gas in a flue gas stream as part of a carbon capture process.

### BACKGROUND

In a combined cycle gas turbine (CCGT) of a natural gas combined cycle power plant, the exhaust from the gas turbine is directed through a heat recovery steam generator (HRSG), where it is treated with ammonia in a selective catalytic reduction (SCR) system to reduce the nitrogen oxides (NOx) content in the flue gas. Ammonia can slip through the SCR as part of the HRSG flue gas, known as ammonia slip.

The HRSG flue gas also contains carbon dioxide. Increasingly, power generators use carbon capture and sequestration (CCS) technology to recover the carbon dioxide before entering the atmosphere. However, CCS technology requires cooling the HRSG flue gas which is commonly achieved through the use of water in a direct contact heat exchanger. As the water condenses and the flue gas is cooled, the ammonia is captured in the condensate. The condensate contains too high a concentration of ammonia to be released to the environment due to health and safety concerns and too high a concentration to be reused in other areas of the industrial plant.

Membrane bioreactors can be used to separate the ammonia from the water. Membrane bioreactors (MBR) is a process that breaks down ammonia via the nitrification process, where ammonia is oxidized to nitrates in a two-step process. The nitrates can be converted to nitrogen by denitrifying bacteria under favorable conditions. Membrane bioreactors have significant capital expenditures, have cumbersome maintenance in order to maintain bacteria growth, do not produce any marketable product, and require specialized professional skills to operate and maintain.

### SUMMARY

Disclosed are methods and systems for treating a flue gas stream. Specifically, disclosed are systems and methods for capturing ammonia gas in a flue gas stream as part of a carbon capture process.

In a first aspect, a method for removing ammonia from a condensate is provided. The method includes the steps of introducing a flue gas to a direct contact cooler, the direct contact cooler configured to reduce a temperature of the flue gas, the flue gas includes ammonia, and contacting the flue gas with a water feed in the direct contact cooler to produce a cooled flue gas and the condensate, where the water feed flows countercurrent to the flue gas, where the water feed includes water, where ammonia in the flue gas is absorbed into the water of the water feed, where the condensate includes water and ammonia. The method further includes the steps of introducing the condensate to an ammonia stripper, the ammonia stripper configured to separate the ammonia from the water, and contacting the condensate with an air feed to produce an air product and a wastewater, where the air feed flows countercurrent to the condensate, where the air feed includes air, where the ammonia transfers from the condensate to the air of the air feed to produce the air product, where the wastewater includes less than 5 ppm ammonia. The method further includes the steps of introducing the wastewater to a treatment unit to produce a treated water, the treatment unit configured to modify the pH of the wastewater, where the pH of the wastewater is in a range of 10.5 to 11, introducing a carbonic acid feed to the treatment unit, where the carbonic acid feed includes carbonic acid, and contacting the wastewater with the carbonic acid feed in the treatment unit to produce the treated water, where the carbonic acid in the carbonic acid feed dissociates to produce hydrogen ions which reduce the pH of the treated water to a range of 7 to 7.5.

In certain aspects, the temperature of cooled flue gas is between 90° F. and 110° F. (32.2° C. and 43.3° C.). In certain aspects, the method further includes the step of recovering carbon dioxide from the cooled flue gas in a carbon capture technology system. In certain aspects, the direct contact cooler is a packed bed vessel, oriented vertically. In certain aspects, the air product includes between 95 vol % and 99 vol % of the ammonia in the condensate. In certain aspects, the ammonia stripper is a packed vessel, oriented vertically. In certain aspects, the air feed includes air from the atmosphere, and the air feed is at a tower operating temperature of the ammonia stripper. In certain aspects, the method further includes the steps of introducing the air product to an ammonia scrubber, introducing a sulfuric acid addition to the ammonia scrubber, where the sulfuric acid addition includes sulfuric acid, reacting the ammonia in the air product with the sulfuric acid to produce ammonium sulphate, where the reaction of ammonia removes ammonia from the air product producing the air feed, and removing a blowdown, where the blowdown includes the ammonium sulphate. In certain aspects, the method further includes the steps of mixing the air product from the ammonia stripper with a filter feed stream upstream of an air filter, filtering the filter feed stream in the air filter to produce a filtered air stream, where the filtered air stream includes ammonia, compressing the filtered air stream in a compressor to produce a compressed air stream, introducing a fuel stream to a combustor, burning the compressed air stream and the fuel stream in the combustor to produce a combustion product, where the ammonia in the compressed air stream is a fuel in the combustor, expanding the combustion product in the turbine to generate energy, where the turbine generates a turbine exhaust as a byproduct, where the turbine exhaust includes nitrogen oxides, recovering heat from the turbine exhaust to produce energy in a heat recovery steam generator, where the turbine exhaust exits the heat recovery steam generator as the flue gas, introducing an ammonia feed to a selective catalytic reduction unit in the heat recovery steam generator, the ammonia feed includes ammonia, and converting nitrogen oxides to nitrogen and water in the selective catalytic reduction unit, where an excess of ammonia from the ammonia feed exits the selective catalytic reduction unit in the flue gas from the heat recovery steam generator. In certain aspects, the method further includes the steps of mixing the air product with a compressed air stream downstream of a compressor, introducing a fuel stream to a combustor, burning the compressed air stream and the fuel stream in the combustor to produce a combustion product, where the ammonia in the compressed air stream is a fuel in the combustor, expanding the combustion product in the turbine to generate energy, where the turbine generates a turbine exhaust as a byproduct, where the turbine exhaust includes nitrogen oxides, recovering heat from the turbine exhaust to produce energy in a heat recovery steam generator, where the turbine exhaust exits the heat recovery steam generator as the flue gas, introducing an ammonia feed to a selective catalytic reduction unit in the heat recovery steam generator, the ammonia feed includes ammonia, and converting nitrogen oxides to nitrogen and water in the selective catalytic reduction unit, where an excess of ammonia from the ammonia feed exits the selective catalytic reduction unit in the flue gas from the heat recovery steam generator. In certain aspects, the method further includes the steps of mixing the air product with an ammonia feed upstream of a selective catalytic reduction unit of a heat recovery steam generator, the ammonia feed includes ammonia, and converting nitrogen oxides to nitrogen and water in the selective catalytic reduction unit, where the ammonia is a reducing agent in the selective catalytic reduction unit, where an excess of ammonia from the ammonia feed exits the selective catalytic reduction unit in the flue gas of the heat recovery steam generator. In certain aspects, the method further includes the step of recycling the treated water to the carbonic acid feed. In certain aspects, further includes a gas selected from the group consisting of carbon dioxide, nitrogen, oxygen, water vapor, and combinations of the same.

In a second aspect, a system for removing ammonia from a condensate is provided. The system includes a direct contact cooler, the direct contact cooler configured to reduce a temperature of a flue gas by contacting the flue gas with a water feed to produce a cooled flue gas and the condensate, where the water feed flows countercurrent to the flue gas, the flue gas includes ammonia, where the water feed includes water, where ammonia in the flue gas is absorbed into the water of the water feed, where the condensate includes water and ammonia, an ammonia stripper fluidically connected to the direct contact cooler, the ammonia stripper configured to separate the ammonia from the water to produce an air product and a wastewater, where the condensate is in direct contact an air feed, where the air feed flows countercurrent to the condensate, where the air feed includes air, where the ammonia transfers from the condensate to the air of the air feed, where the wastewater includes less than 5 ppm ammonia, and a treatment unit, the treatment unit configured to modify the pH of the wastewater to produce a treated water, where the pH of the wastewater is in a range of 10.5 to 11, where the pH of the treated water is in a range of 7 to 7.5, where the treatment unit includes a carbonic acid feed includes carbonic acid, where the carbonic acid reacts with the water in the wastewater and the ammonia in the wastewater to modify the pH of the wastewater and to produce ammonium bicarbonate.

In certain aspects, the system further includes a carbon capture technology system fluidically connected to the direct contact cooler, the carbon capture technology system configured to recover carbon dioxide from the cooled flue gas. In certain aspects, the system further includes an air filter fluidically connected to the ammonia stripper, where the air product is mixed with a filter feed stream upstream of the air filter, the air filter is configured to filter the filter feed stream to produce a filtered air stream, where the filtered air stream includes ammonia, a compressor fluidically connected to the air filter, the compressor configured to produce a compressed air stream, a combustor fluidically connected to the compressor, the combustor configured to burn the compressed air stream and a fuel stream to produce a combustion product, where the ammonia in the compressed air stream is a fuel in the combustor, a turbine fluidically connected to the combustor, the turbine configured to expand the combustion product to generate energy, where the turbine generates a turbine exhaust as a byproduct, where the turbine exhaust includes nitrogen oxides, a heat recovery steam generator fluidically connected to the turbine, the heat recovery steam generator configured to recover heat from the turbine exhaust to produce energy and the flue gas, and a selective catalytic reduction unit in the heat recovery steam generator, the selective catalytic reduction unit configured to convert nitrogen oxides and ammonia to nitrogen and water, where an ammonia feed includes ammonia is introduced to the selective catalytic reduction unit, where an excess of ammonia from the ammonia feed exits the selective catalytic reduction unit in the flue gas from the heat recovery steam generator. In certain aspects, the system further includes a compressor fluidically connected to the ammonia stripper, where the air product is mixed with a compressed air stream downstream of the compressor, a combustor fluidically connected to the compressor, the combustor configured to burn the compressed air stream and a fuel stream to produce a combustion product, where the ammonia in the compressed air stream is a fuel in the combustor, a turbine fluidically connected to the combustor, the turbine configured to expand the combustion product to generate energy, where the turbine generates a turbine exhaust as a byproduct, where the turbine exhaust includes nitrogen oxides, a heat recovery steam generator fluidically connected to the turbine, the heat recovery steam generator configured to recover heat from the turbine exhaust to produce energy and the flue gas, and a selective catalytic reduction unit in the heat recovery steam generator, the selective catalytic reduction unit configured to convert nitrogen oxides and ammonia to nitrogen and water, where an ammonia feed includes ammonia is introduced to the selective catalytic reduction unit, where an excess of ammonia from the ammonia feed exits the selective catalytic reduction unit in the flue gas from the heat recovery steam generator. In certain aspects, the system further includes a selective catalytic reduction unit of a heat recovery steam generator, the selective catalytic reduction unit fluidically connected to the ammonia stripper, the selective catalytic reduction unit configured to convert nitrogen oxides and ammonia to nitrogen and water, the heat recovery steam generator configured to produce energy and the flue gas, where the air product is mixed with an ammonia feed, the ammonia feed includes ammonia, where an excess of ammonia from the ammonia feed exits the selective catalytic reduction unit in the flue gas.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a process flow diagram of an embodiment of the ammonia slip mitigation process containing an ammonia stripper.

FIG. 2 is a process flow diagram of an embodiment of the ammonia slip mitigation process containing an ammonia stripper and an ammonia scrubber.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The systems and methods provide ammonia slip mitigation by separating ammonia from direct contact cooler condensate, thus reducing the ammonia to single digit levels in the remaining condensate, while reducing the pH so the condensate can be re-used in the plant. Advantageously, the ammonia slip mitigation system and methods enables reuse of the condensate by recycling it to the plant. This is an advantage over systems that convert the ammonia to nitrogen in which the water is used in the process and not recovered. Advantageously, the ammonia slip mitigation systems and methods can recover ammonia in a technically simple manner with a reduced footprint. Advantageously, the ammonia slip mitigation systems and methods can recover ammonia for use as a fuel either internally or as a marketable product. Advantageously, the ammonia slip mitigation systems and methods can recover ammonia for recycle in the combined cycle power plant as a reducing agent or as a fuel. Advantageously, the ammonia slip mitigation systems and methods can utilize carbon dioxide recovered from the combined cycle power plant thus reducing the overall carbon footprint of the plant. Advantageously, the systems and methods can result in a zero ammonia slip plant because all ammonia that exits the selective catalytic reduction unit is recycled as fuel, as a reducing agent, or is converted to an inert compound.

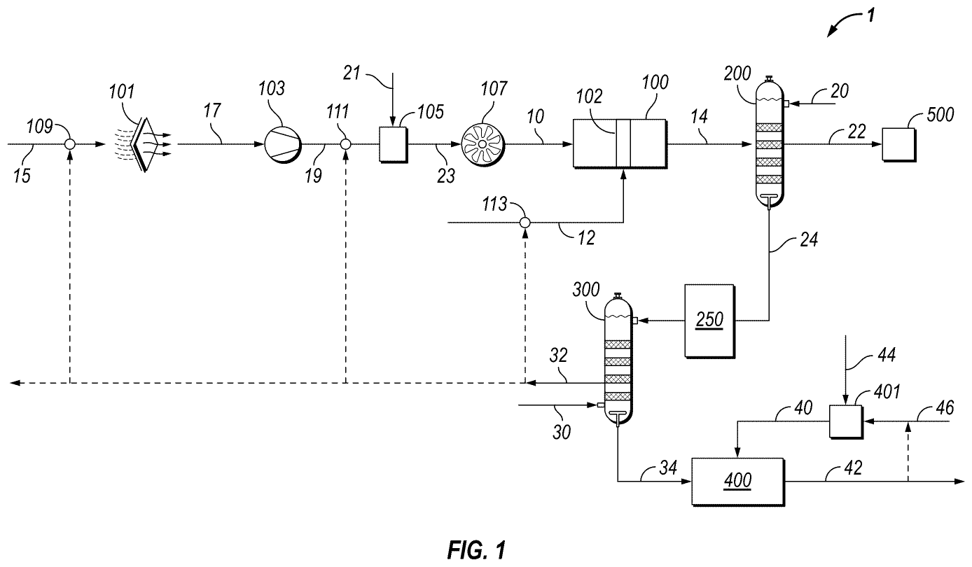

Referring to FIG. 1, a process flow diagram of an ammonia slip mitigation system is provided. Heat recovery steam generator 100 receives turbine exhaust 10 and ammonia feed 12. Heat recovery steam generator 100 is part of combined cycle power plant 1. Combined cycle power plant 1 also includes air filter 101, compressor 103, combustor 105, and turbine 107. One of skill in the art will understand that these are only certain units of a combined cycle power plant.

Turbine exhaust 10 can include nitrogen oxides, carbon dioxide, oxygen, water vapor, and combinations of the same. Heat recovery steam generator 100 is an energy recovery heat exchanger that recovers heat from turbine exhaust 10 and converts the heat to steam which can be used to produce energy. Heat recovery steam generator 100 can include a selective catalytic reduction unit 102 as part of an emissions control system. Selective catalytic reduction unit 102 includes a catalyst. In selective catalytic reduction unit 102 of heat recovery steam generator 100, the nitrogen oxides in turbine exhaust 10 can react with ammonia from ammonia feed 12 over the catalyst to produce nitrogen and water.

Flue gas 14 exits heat recovery steam generator 100. Flue gas 14 can include carbon dioxide, nitrogen, oxygen, water vapor, ammonia, and combinations of the same. Flue gas 14 is at a temperature less than the temperature of turbine exhaust 10. One of skill in the art will appreciate that sulfur oxides, or SOx are negligible in a combined cycle power plant and the SOx that are present are converted to hydrogen sulfide and are not required to be treated. Flue gas 14 is in the absence of organic matter, heavy metals, and volatile organic compounds. The ammonia in flue gas 14 occurs due to leakage or slip from the selective catalytic reduction unit 102, where ammonia introduced from ammonia feed 12 exits with the flue gas rather than being totally reacted. The temperature of flue gas 14 can be between 170° F. and 180° F. (76.6° C. and 82.2° C.). Flue gas 14 is introduced to direct contact cooler 200.

Direct contact cooler 200 can be any type of heat exchanger where the heat transfer takes place directly between two fluid streams. Direct contact cooler 200 can be a packed bed vessel, vertically oriented. Water feed 20 can be introduced at or proximate the top of direct contact cooler 200. Water feed 20 can include water. The flow rate of water feed 20 can depend on the size of direct contact cooler 200 and volume of flue gas 14. Water feed 20 can be at a temperature between 125° F. and 130° F. (51.6° C. and 54.4° C.). As the water in water feed 20 flows down through direct contact cooler 200, the flue gas is cooled and components in the flue gas can be absorbed into the flowing water. In particular, water vapor and ammonia present in flue gas 14 can be absorbed by the water in direct contact cooler 200. Direct contact cooler 200 produces cooled flue gas 22 and condensate 24. The temperature of cooled flue gas 22 can be between 90° F. and 110° F. (32.2° C. and 43.3° C.), and alternately 100° F. (37.7° C.).

Condensate 24 can contain water and ammonia. The amount of ammonia in condensate 24 can be between 100 parts-per-million (ppm) and 1000 ppm, alternately between 100 ppm and 500 ppm, alternately between 100 ppm and 150 ppm, and alternately 120 ppm. The flow rate of condensate 24 can depend on the flow rate of water feed 20, the size of direct contact cooler 200, including the volume of packing, and the volume of flue gas 14. In at least one embodiment, the flow rate of condensate 24 is between 600 gallons per minute (gpm) and 1200 gpm (136.3 cubic meters per hour (m³/h) and 272.5 m³/h) and alternately between 800 gpm and 1000 gpm (181.7 m³/h and 227.125 m³/h). In at least one embodiment, the flow rate of condensate 24 is 900 gpm (204.412 m³/h). Condensate 24 can contain less than 0.1 vol % carbon dioxide, alternately less than 0.01 vol % carbon dioxide, and alternately less than 0.001 vol %. Condensate 24 is introduced to ammonia stripper 300.

Ammonia stripper 300 can be any type of vessel or tower that contains internals capable of separating volatile components from a liquid stream into an air stream. In at least one embodiment, ammonia stripper 300 is a packed vessel. Ammonia stripper 300 can be oriented vertically. The specific design criteria, including type of packing, column height, height of packing materials, and diameter can depend on the target amount of ammonia in wastewater 34. Thus, one of skill in the art will understand that the design criteria must also take into consideration condensate flow rate and amount of ammonia in the condensate. Condensate 24 is introduced at or proximate the top of ammonia stripper 300 and above the top of the tower internals. In at least one embodiment, condensate 24 can be introduced through a distributor. The condensate flows down through the tower internals in ammonia stripper 300. Air feed 30 can be introduced below the bottom of the tower internals and above the top of the reservoir in the bottom of ammonia stripper 300. Air feed 30 can contain air pulled from the atmosphere. The air flows up through the tower internals in ammonia stripper 300. As air from air feed 30 flows upward through ammonia stripper 300 ammonia from condensate 24 is transferred into the air and exits in air product 32. Ammonia stripper 300 can have between 90% and 99% efficiency, alternately between 95 and 99% efficiency, and alternately between 98% and 99% efficiency. Air product 32 contains between 90 vol % and 99 vol % of the ammonia in condensate 24, alternately between 95 vol % and 99 vol % of the ammonia in condensate 24, and alternately between 98 vol % and 99 vol % of the ammonia in condensate 24.

The flow rate of air feed 30 can be between 60,000 cubic feet per minute (cfm) and 300,000 cfm, alternately between 70,000 cfm and 200,000 cfm, and alternately between 70,000 cfm, and 150,000 cfm. To maximize separation efficiency in ammonia stripper 300, air feed 30 can be heated to tower operating temperature prior to introduction to ammonia stripper 300. Ammonia stripper 300 tower operating temperature can be the temperature of condensate 24. Alternately, ammonia stripper 300 tower operating temperature can be between 50° F. and 150° F. and alternately between 75° F. and 125° F. In at least one embodiment, the temperature in ammonia stripper 300 can be 125° F. Air feed 30 can be heated to tower operating temperature. Maintaining the temperature of air feed 30 at tower operating temperature is critical for operational efficiency. By way of example only, if the tower operating temperature is 125° F. and the temperature of air feed 30 drops to 110° F., the ammonia removal efficiency can drop to 75%, which would result in an ammonia concentration in the wastewater increasing to 30 mg/L, or about 4.2 vol %. The specific design temperature and flow rate of air feed 30 can impact the separation of ammonia in condensate 24, thus, the design temperature and flow rate of air feed 30 can also impact the design criteria of ammonia stripper 300, including number of towers, diameter, column height, and height of packing materials.

In at least one embodiment, air feed 30 can be heated to tower operating temperature using waste heat from other areas of combined cycle plant power plant 1 or carbon capture technology system 500. In at least one embodiment, air feed 30 can be heated and saturated using waste hot water from carbon capture technology system 500 coupled downstream of direct contact cooler 200. Carbon capture technology system 500 can include towers, heat exchangers, pumps, and other equipment designed to separate carbon dioxide from other gases. In at least one embodiment, carbon capture technology system 500 produces waste heat between 77 and 235 MMBTU/hr that can be used to heat and saturate air feed 30.

In an alternate embodiment, condensate 24 can be introduced to solid contact clarifier 250. Solid contact clarifier 250 can be any type of water purification clarifiers capable of removing suspended solids, such as metals, salts, and organic materials, in the form of sediments, flocculants, or other precipitates. In at least one embodiment, solid contact clarifier 250 is a solid contact clarifier. Solid contact clarifier 250 can be included when the total suspended solids (TSS) in condensate 24 is greater than 10 mg/L or 10 ppm. The suspended solids in condensate 24 collect in solid contact clarifier 250 and can be periodically removed from the bottom. Solid contact clarifier 250 can remove total suspended solids to 10 ppm or less in the stream entering ammonia stripper 300.

As shown in FIG. 1, air product 32 can be recycled to combined cycle power plant 1.

Air product 32 can be used in combined cycle power plant 1 as a fuel or as a reducing agent depending on where it is recycled.

In at least one embodiment, air product 32 optionally can be mixed with filter feed stream 15 upstream of air filter 101 at first gas mixer 109. Filter feed stream 15 can be filtered in air filter 101 to produce filtered air stream 17. Advantageously, mixing air product 32 with filter feed stream 15 can remove any particulates or other materials in air product 32, thus helping to clean up air product 32 and reduce the need for additional equipment on the air product stream from ammonia stripper 300.

In an alternate embodiment, air product 32 optionally can be mixed with compressed air stream 19 from compressor 103 in second gas mixer 111. Compressed air stream 19, optionally with the contents of air product 32, can be introduced to combustor 105, along with fuel stream 21. Combustor 105 can be any type of combustion chamber capable of combusting a fuel-air mixture to increase a temperature of the gas before introduction to a gas turbine. Fuel stream 21 can be any type of hydrocarbon-containing fuel stream that can be mixed with air and combusted. In at least one embodiment, fuel stream 21 includes natural gas. Combustion product 23 is introduced to the inlet of turbine 107. Combustion product 23 expands in turbine 107 causing the turbine to spin a generator (not shown) and create electricity. One of skill in the art can appreciate that compressor 103, combustor 105, and turbine 107 may form part of one unit referred to as a gas turbine.

Mixing air product 32 with filter feed stream 15 or compressed air stream 19 can result in the ammonia in air product 32 being used as a fuel in combustor 105. When used as a fuel in combustor 105 the ammonia from air product 32 is entirely or substantially burned in combustor 105. The operating conditions of combined cycle power plant 1 through compressor 103, combustor 105, and turbine 107 are such that any ammonia remains in gaseous form and does not liquefy. In at least one embodiment, the temperature in compressed air stream 19 is greater than 400° C.

In an alternate embodiment, air product 32 optionally can be mixed with auxiliary boilers as fuel.

In an alternate embodiment, air product 32 optionally can be mixed with ammonia feed 12 in third gas mixer 113 and then can be introduced to selective catalytic reduction unit 102. Mixing air product 32 with ammonia feed 12 can result in the ammonia in air product 32 being used as a reducing agent in the reactions to convert nitrogen oxides in turbine exhaust 10 to nitrogen and water.

First gas mixer 109, second gas mixer 111, and third gas mixer 113 can be any type of unit capable of mixing two gas streams together with variable flow. One of skill in the art can appreciate that the systems and methods for ammonia slip mitigation can include instrumentation and valves to control the flow of air product 32 to select the configuration for optimal plant operation.

In an alternate embodiment, air product 32 can be mixed with the feedwater system as a reducing agent for all-volatile treatment (reducing) for water treatment.

Advantageously, recycling air product 32 to combined cycle power plant 1 reduces the ammonia being produced to the environment by the process and captures the ammonia as a fuel source or as reducing agent. In an alternate embodiment, air product 32 can be introduced to a stack and released to the atmosphere. One of skill in the art can appreciate the treatment of air product 32 can depend on the specific conditions and needs of combined cycle power plant 1.

Wastewater 34 exits the bottom of ammonia stripper 300. Wastewater 34 contains between 1 vol % and 4 vol % of the ammonia in condensate 24, and alternately between 1 vol % and 2 vol % of the ammonia in condensate 24. The amount of ammonia in wastewater 34 can be designed to meet environmental regulations. In at least one embodiment, the amount of ammonia in wastewater 34 is less than 5 ppm and alternately between 1 ppm and 5 ppm. Maintaining an amount of ammonia in wastewater 34 ensures the ammonia is below environmental regulations. Wastewater 34 has a pH in the range of 10.5 to 11. Wastewater 34 can be introduced to treatment unit 400.

Treatment unit 400 can be any type of unit capable of reducing the pH of wastewater 34. Treatment unit 400 can be a pH control unit that utilizes carbonic acid to convert the ammonia in wastewater 34 to ammonia bicarbonate. Carbonic acid feed 40 is introduced to treatment unit 400. Carbonic acid feed 40 can include carbonic acid produced from carbon dioxide recovered from cooled flue gas 22 using carbon capture technology system 500. Carbonic acid feed 40 can include water recovered as treated water 42 from treatment unit 400. In at least one embodiment, carbonic acid feed 40 can be produced in carbonic acid unit 401 by reacting carbon dioxide and water. Carbon dioxide can be supplied from carbon dioxide feed 44. Carbon dioxide feed 44 can include carbon dioxide recovered from carbon capture technology system 500 downstream of direct contact cooler 200. The water in carbonic acid unit 401 can include water from treated water 42 or from makeup water 46.

Carbonic acid feed 40 can be mixed with wastewater 34 in treatment unit 400 to reduce the pH of wastewater 34. In treatment unit 400, carbonic acid in carbonic acid feed 40 reacts with the ammonia in wastewater 34 to produce ammonium bicarbonate. The ammonium bicarbonate remains in treated water 42. Advantageously, at an ammonia level of less than 5 ppm in wastewater 34 the amount of ammonium bicarbonate in treated water 42 can allow treated water 42 to be recycled to other areas of combined cycle power plant 1 without the amount of ammonium bicarbonate causing operating problems in the plant. Treatment unit 400 can include instrumentation to monitor pH of treated water 42. The amount of ammonia in the wastewater affects the pH of the water. As carbonic acid feed 40 mixes with wastewater 34, the carbonic acid in carbonic acid feed 40 dissociates to form hydrogen ions (H+) and bicarbonate ions (HCO₃⁻). The bicarbonate ions react with ammonia (NH₃) to form the ammonium bicarbonate. The formation of H+ ions neutralizes the pH of the water in treatment unit 400. As the wastewater is neutralized due to the carbonic acid reacting with the water and the ammonia, the ammonium bicarbonate is formed and ultimately the pH of the wastewater is neutralized. Monitoring the pH of the treated water can provide an indication of the amount of ammonia in the water and the amount of carbonic acid can be adjusted as necessary to react with and remove an additional amount of ammonia. If the pH of treated water 42 is outside of a targeted range the flow rate of carbonic acid feed 40 can be modified to adjust the pH to within the targeted range. In at least one embodiment, maintaining the pH to within the targeted range ensures complete conversion of the ammonia. Treated water 42 can have a targeted pH in a range between 7 and 7.5. A targeted pH in the range of 7 to 7.5 results in the targeted water being neutral or near neutral allowing the targeted water to be reused in the combined cycle power plant. Targeted water 42 can be recycled to combined cycle power plant 1, can be mixed with carbon dioxide as the carrier fluid to produce the carbonic acid for carbonic acid feed 40, or combinations of the same. Advantageously and unexpectedly, the treatment unit 400 enables the wastewater to be treated such that the treated water can be reused conserving water.

Advantageously, carbonic acid injection can result in a lower amount of total dissolved solids compared to sulfuric acid injection. Increased total dissolved solids in the treated water can result in additional equipment such as filters, collection equipment, and solid disposal equipment.

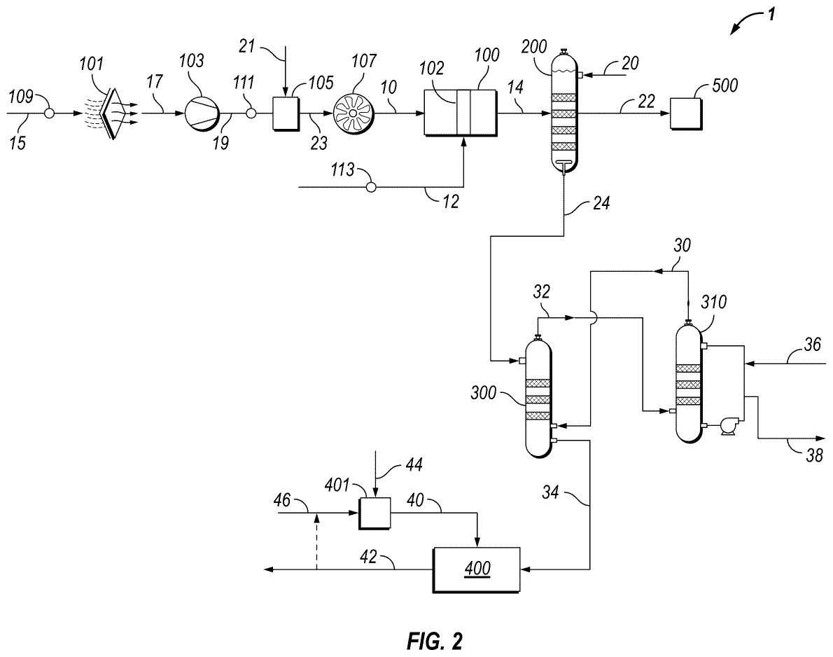

In an alternate embodiment according to FIG. 2, ammonia scrubber 310 is downstream of ammonia stripper 300. Air product 32 is introduced to ammonia scrubber 310 and air feed 30 is recycled from ammonia scrubber 310 to ammonia stripper 300. One of skill in the art will appreciate that on start-up an external air stream may need to be introduced to the system until flow rates reach operating condition for stripping ammonia from condensate 24.

In ammonia scrubber 310, sulfuric acid addition 36 is introduced. Sulfuric acid addition 36 contains sulfuric acid in an amount between 96 wt % and 98 wt % sulfuric acid. Sulfuric acid addition 36 can have a flow rate of between 5 gallons per hours (10 L/h) and 15 gallons per hours (56.8 L/h), alternately 8 gallons per hour (30.3 L/h) and 12 gallons per hour (45.4 L/h), and alternately 10 gallons per hour (37.8 L/hr). The sulfuric acid in sulfuric acid addition 36 reacts with the ammonia in air product 32 to produce ammonium sulphate. The ammonium sulphate is removed in blowdown 38, which contains ammonium sulphate in an amount between 25 vol % and 30 vol %. Ammonia stripper 300 produces wastewater 34. Blowdown 38 can be treated in plant wastewater treatment systems, stored, or hauled away for sale or disposal.

The embodiment of FIG. 2 advantageously allows for air feed 30 to be heated and saturated in ammonia scrubber 310. With an ammonia scrubber, the air temperature of the air feed to the ammonia stripper approaches the temperature of the liquid feed to the ammonia stripper. With once-through air as described with reference to the embodiment of FIG. 1, the design temperature approaches the wet-bulb temperature of the outdoor air. This temperature, being much lower, significantly increases the air-to-water requirement to get the same removal efficiency, which results in a much larger stripper or multiple strippers for the same liquid flow rate.

While exemplary embodiments have been described with reference to a selective catalytic reduction unit as part of a heat recovery steam generator, one of skill in the art can appreciate that any natural gas or coal power generator that uses selective catalytic reduction to control the nitrogen oxides and uses carbon capture and sequestration technology to capture carbon dioxide can use the ammonia slip mitigation system and methods.

The methods and systems of ammonia slip mitigation are in the absence of steam in the ammonia stripper. Advantageously, using air instead of steam enables the air product to be recycled to the combined cycle power plant as a fuel or as a reducing agent. The methods and systems of ammonia slip mitigation are in the absence of chilled ammonia processes. Chilled ammonia processes use ammonia at temperatures between 0° C. and 20° C. to capture carbon dioxide from a flue gas. The ammonia slip mitigation systems and methods are in the absence of capturing carbon dioxide in the direct contact cooler, the ammonia stripper, or the treatment unit. In embodiments in the absence of ammonia scrubbers, the ammonia slip mitigation systems and methods are in the absence of processes to recover fertilizers, such as ammonium sulphate or ammonium nitrate. The methods and systems for ammonia slip mitigation are in the absence of membrane bioreactors and in the absence of bacteria growth for removal of ammonia. The methods and systems of ammonia slip mitigation are in the absence of added alkaline components, such as lye, to the condensate from the direct contact cooler. Adding alkaline components to the condensate from the direct contact cooler can increase scaling and corrosion in the ammonia stripper. Advantageously and unexpectedly, the ammonia stripper can operate to separate 90 vol % to 99 vol % of the ammonia in the condensate using air without the need to add alkaline components in the condensate.

Example 1. Example 1 is a comparison of a system with both an ammonia stripper and ammonia scrubber to a system with only an ammonia stripper. Simulation 1 was based on FIG. 2 containing both ammonia stripper 300 and ammonia scrubber 310. Simulation 2 was based on FIG. 1 containing only ammonia stripper 300. In both simulations, condensate 24 has a flow rate of 900 gpm (204.412 m³/h), a pH of 11, a temperature 125° F., an amount of ammonia of 122 ppm, and total suspended solids between 10 ppm and 130 ppm. Both simulations were modeled with the same packing materials and packing height in the ammonia stripper.

In simulation 1, to produce a wastewater 34 that has an amount of ammonia of less than 10 ppm, or about 1.3 vol %, the flow rate of air feed 30 is set to 72,000 actual cubic feet per minute (acfm), saturated and at a temperature 125° F. Ammonia stripper 300 was simulated as a 12.5 foot diameter tower. Ammonia scrubber 310 produces blowdown 38 containing a 30% ammonium sulphate solution at a rate of 1.1 gallons per minute.

Air product 32 of ammonia stripper 300 contains an ammonia mass flow of about 52.6 lb/hr.

Without an ammonia scrubber, air feed 30 must be heated and saturated from ambient to the temperature in ammonia stripper 300, requiring a heat load, to achieve an amount of ammonia of less than 10 ppm. Table 1 illustrates the impact on size of ammonia stripper 300, the flow rate of air feed 30, and the heat load to heat and saturate air feed 30 based on different temperatures in ammonia stripper 300. Heat loads are simulated assuming an increase from 10° F. to operating temperature in ammonia stripper 300.

TABLE 1
Impact of temperature in ammonia stripper on different parameters.

| | | Ammonia stripper | |
|---|---|---|---|
| Temperature | Air Feed 30 | 300 Tower Diameter | Heat Load |
| 125° F. | 72,000 ACFM | 12.5 ft - 1 tower | 30,000,000 Btu/hr |
| 100° F. | 130,000 ACFM | 12 ft - 2 towers | 20,000,000 Btu/hr |
| 70° F. | 275,000 ACFM | 14 ft - 3 towers | 8,000,000 Btu/hr |

Example 1 illustrates that eliminating the ammonia scrubber can still produce wastewater 34 with an amount of ammonia of less than 10 ppm. The heat load to heat air feed 30 can be managed by heat exchange with other parts of the process, such as carbon capture technology system 500.

Advantageously, Example 1 illustrates that air product 32 can be recycled to combined power plant 1. Typical air flow through a turbine is greater than 5 million lb/hr, so mixing an ammonia flow rate of 52 lb/hr with the air product 32 and the typical air flow through a turbine result in an amount of ammonia of about 9 ppm, which can be handled by a turbine.

Example 2. Example 2 is a simulation of treatment unit 400 illustrating the amount of carbon dioxide required to neutralize wastewater 34 based on FIG. 1. At 900 gpm in wastewater 34 and a pH of 10.7, 126 lb/hr carbon dioxide is required to neutralize the wastewater. The simulation shows that treatment unit 400 can be used to neutralize the wastewater to a final pH of about 7.5 and that any ammonium bicarbonate produced does not disrupt the neutralization process.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

That which is claimed is:

1. A method for removing ammonia from a condensate, the method comprising the steps of:
introducing a flue gas to a direct contact cooler, the direct contact cooler configured to reduce a temperature of the flue gas, the flue gas comprising ammonia;
contacting the flue gas with a water feed in the direct contact cooler to produce a cooled flue gas and the condensate, where the water feed flows countercurrent to the flue gas, where the water feed comprises water, where ammonia in the flue gas is absorbed into the water of the water feed, where the condensate comprises water and ammonia;
introducing the condensate to an ammonia stripper, the ammonia stripper configured to separate ammonia from the water;
contacting the condensate with an air feed to produce an air product and a wastewater, where the air feed flows countercurrent to the condensate, where the air feed comprises air, where the ammonia transfers from the condensate to the air of the air feed to produce the air product, where the wastewater comprises less than 5 ppm ammonia;
introducing the wastewater to a treatment unit to produce a treated water, the treatment unit configured to modify the pH of the wastewater, where the pH of the wastewater is in a range of 10.5 to 11;
introducing a carbonic acid feed to the treatment unit, where the carbonic acid feed comprises carbonic acid; and
contacting the wastewater with the carbonic acid feed in the treatment unit to produce the treated water, where the ammonia in the wastewater reacts with the carbonic acid in the carbonic acid feed to produce ammonium bicarbonate, where the carbonic acid in the carbonic acid feed dissociates to produce hydrogen ions which reduce the pH of the treated water to a range of 7 to 7.5.

2. The method of claim 1, where the temperature of cooled flue gas is between 90° F. and 110° F.

3. The method of claim 1, further comprising the step of recovering carbon dioxide from the cooled flue gas in a carbon capture technology system.

4. The method of claim 1, where the direct contact cooler is a packed bed vessel, oriented vertically.

5. The method of claim 1, where the air product comprises between 95 vol % and 99 vol % of the ammonia in the condensate.

6. The method of claim 1, where the ammonia stripper is a packed vessel, oriented vertically.

7. The method of claim 1, where the air feed comprises air from atmosphere, where the air feed is at a tower operating temperature of the ammonia stripper.

8. The method of claim 1, further comprising the steps of:
introducing the air product to an ammonia scrubber;
introducing a sulfuric acid addition to the ammonia scrubber, where the sulfuric acid addition comprises sulfuric acid;
reacting the ammonia in the air product with the sulfuric acid to produce ammonium sulphate, where the reaction of ammonia removes ammonia from the air product producing the air feed; and
removing a blowdown, where the blowdown comprises the ammonium sulphate.

9. The method of claim 1, further comprising the steps of:
mixing the air product with a filter feed stream upstream of an air filter;
filtering the filter feed stream in the air filter to produce a filtered air stream, where the filtered air stream comprises ammonia;
compressing the filtered air stream in a compressor to produce a compressed air stream;
introducing a fuel stream to a combustor;
burning the compressed air stream and the fuel stream in the combustor to produce a combustion product, where the ammonia in the compressed air stream is a fuel in the combustor;
expanding the combustion product in a turbine to generate energy, where the turbine generates a turbine exhaust as a byproduct, where the turbine exhaust comprises nitrogen oxides;
recovering heat from the turbine exhaust to produce energy in a heat recovery steam generator, where the turbine exhaust exits the heat recovery steam generator as the flue gas;
introducing an ammonia feed to a selective catalytic reduction unit in the heat recovery steam generator, the ammonia feed comprising ammonia; and
converting nitrogen oxides to nitrogen and water in the selective catalytic reduction unit, where an excess of ammonia from the ammonia feed exits the selective catalytic reduction unit in the flue gas from the heat recovery steam generator.

10. The method of claim 1, further comprising the steps of:
mixing the air product with a compressed air stream downstream of a compressor;
introducing a fuel stream to a combustor;
burning the compressed air stream and the fuel stream in the combustor to produce a combustion product, where the ammonia in the compressed air stream is a fuel in the combustor;
expanding the combustion product in a turbine to generate energy, where the turbine generates a turbine exhaust as a byproduct, where the turbine exhaust comprises nitrogen oxides;
recovering heat from the turbine exhaust to produce energy in a heat recovery steam generator, where the turbine exhaust exits the heat recovery steam generator as the flue gas;
introducing an ammonia feed to a selective catalytic reduction unit in the heat recovery steam generator, the ammonia feed comprising ammonia; and
converting nitrogen oxides to nitrogen and water in the selective catalytic reduction unit, where an excess of ammonia from the ammonia feed exits the selective catalytic reduction unit in the flue gas from the heat recovery steam generator.

11. The method of claim 1, further comprising the steps of:
mixing the air product with an ammonia feed upstream of a selective catalytic reduction unit of a heat recovery steam generator, the ammonia feed comprising ammonia; and
converting nitrogen oxides to nitrogen and water in the selective catalytic reduction unit, where the ammonia is a reducing agent in the selective catalytic reduction unit, where an excess of ammonia from the ammonia feed exits the selective catalytic reduction unit in the flue gas of the heat recovery steam generator.

12. The method of claim 1, further comprising the step of recycling the treated water to the carbonic acid feed.

13. The method of claim 1, the flue gas further comprising a gas selected from the group consisting of carbon dioxide, nitrogen, oxygen, water vapor, and combinations of the same.
